(19) United States
(12) Patent Application Publication
(10) Pub. No.: US 2016/0358256 A1
(43) Pub. Date: Dec. 8, 2016

(54) SYSTEM AND METHOD OF PRICE DISCOVERY FOR EXCHANGE MARKET

(71) Applicant: Noah P. Healy, Charlottesville, VA (US)

(72) Inventor: Noah P. Healy, Charlottesville, VA (US)

(21) Appl. No.: 15/171,621

(22) Filed: Jun. 2, 2016

Related U.S. Application Data
(60) Provisional application No. 62/169,666, filed on Jun. 2, 2015.

(51) Int. Cl. G06Q 40/04; G06Q 30/02; G06Q 40/06

(52) U.S. Cl. CPC G06Q 40/04; G06Q 40/06; G06Q 30/0202

(57) ABSTRACT

A method and system implementing a combination of a sequence of fixed price call auctions with a positive sum pari-mutuel information gathering to facilitate exchange of goods and services when the producers and consumers are complementary hedgers is disclosed. The method and system separates qualitatively different roles into completely separate activities, such that it becomes possible to designate to cost/reward for each aspect of market operation independently. As a result, transactional costs can be arbitrarily lowered while return on informed speculation can be arbitrarily raised and fraud can be made arbitrarily more costly or less rewarding.

### CROSS-REFERENCE TO RELATED APPLICATION(S)

This application claims priority to, and the benefit of, co-pending U.S. Provisional Application 62/169,666, filed Jun. 2, 2015, for all subject matter common to both applications. The disclosure of said provisional application is hereby incorporated by reference in its entirety.

### FIELD OF THE INVENTION

The present invention relates to exchange markets. In particular, the present invention relates to discovering and publishing clearing prices of commodities within exchange markets using a different logical construct for an exchange market, which dictates a different set of rules for interaction of the relevant participants.

### BACKGROUND

Generally, methods and systems for operating exchange markets implement processes of trading future instruments to buy and sell risk associated with buying and selling. These methods and systems are roughly nine centuries old and in spite of the great increases in speed and leverage and steep decline in fees per trade that modern technology has affected, the systems themselves would be recognizable to early Renaissance Venetians. These methods and systems rely on individual competition to drive them and suffer from well-known flaws, such as manipulative practices, money laundering, and crash instability, some of which require regulation and laws in an attempt to control. Additionally the total earnings of purely financial actors within the exchange markets are uncontrolled and impossible to appropriately attribute. At the same time, moving off exchanges seriously degrades the information value of prices causing long term damage in industries (e.g., commodity producers) supported by the exchange markets.

For commodities, several systems and methods are commonly used to discover and communicate price information, but the most effective and therefore most important are exchange markets. At a high level, exchange markets traditionally work by constantly maintaining a balance between supply and demand and moving the price point for commodities to a position such that both sides of the supply and demand are in harmony. By fixing certain dates, standardizing contracts to deliver or receive goods, and creating and trading these contracts, exchange markets produce accurate future price sentiment and a historical record of price evolution.

However, these systems and methodologies experience some shortcomings. Primarily, advances in communication technology and modern computers have driven markets to speed up and have pushed them to levels that fundamentally alter the behavior of the marketplace as information is now communicated too quickly for humans to process (e.g., a human will place a trade on a commodity with a price that is changing by the microsecond). The resulting microsecond transactions have not resulted in appreciable improvement in either price stability or lower transaction costs for the entire system. Instead, observation in the market reveal that deal flow is increasing faster than fees fall. Additionally, existing marketplaces require liquidity in order to discover prices to be provided by persons other than the producers and consumers and thus external liquidity must be attracted by return, which contributes to transaction costs.

Without trades taking place, the marketplace has no price to offer. With market speed driven by computational technology that far outstrips the rate of productivity improvement in the rest of the economy, inevitably trade volume outstrips trades for delivery. The complexity of the resulting marketplace degrades the value of the information it provides as the difficulty of evaluating that information increases. These factors combine to make liquidity return proportional to the marketplace's transaction costs. Within existing exchange systems, lowering transaction costs can reduce liquidity return which in turn damages or destroys the market's function.

### SUMMARY

As a result of advances in technology and the speed of transactions on the marketplace, there is a need for a new logical construct for exchange markets that provides a stable, safe, and low cost price discovery within exchange markets. The present invention is directed toward further solutions to address this need, in addition to having other desirable characteristics. Specifically, by linking a positive sum forecasting market to a negative sum clearing house in a mutually negative reinforcement control loop, the socially and economically useful features of an exchange market can be produced with spread (cost) and return being independently settable attributes of the resulting marketplace. The present invention provides such features by providing a temporal sequence of clearing prices and accepting future price speculation from speculators along with an investment, the investments are combined into a better pool, and the speculators who most correctly predicted the future prices are rewarded out of the betting pool utilizing a pari-mutuel payout.

By allocating returns on investments based on information measurement and allocating trade to minimize global marginal and logistic costs, the resulting market will strictly dominate existing systems and methods. The present invention also handles transactions between producers and consumers who also are able to utilize the pricing information provided by speculators when determining how much of a commodity to buy or sell. This process arrangement and the algorithms that support it allow the separation of speculation from trading so that speculator incentives can be inverted to align with producers and consumers. As such, a new logical construct for an exchange market results, with a different set of rules for interaction of the relevant participants. In particular, the present invention provides a system and method for exchange markets with a different logical construct which dictates a different set of rules for interaction of the relevant participants (e.g., mechanical interactions between the parties to effect a transaction)

In accordance with an example embodiment of the present invention, a system for discovering and publishing clearing prices of commodities within exchange markets is provided. The system includes an intermediary market server which simultaneously publishes price for a plurality of commodities to at least one speculator device associated with a speculator, at least one producer device associated with a producer of at least one commodity, and at least one consumer device associated with a consumer of at least one commodity. The at least one speculator device exchanges data with the intermediary market server related to purchasing interests in at least one commodity of the plurality of commodities. The at least one producer device exchanges data with the intermediary market server related to selling the at least one commodity. The at least one consumer device exchanges data with the intermediary market server related to buying the at least one commodity.

In accordance with aspects of the present invention, the published price is received from one or more of the at least one speculator device. In accordance with aspects of the present invention, the at least one producer device is configured to submit an offer to sell a portion of the at least one commodity at the published price. In accordance with aspects of the present invention, the at least one consumer device submits an offer to buy the portion of the at least one commodity at the published price. In accordance with aspects of the present invention, the intermediary market server resolves the offer to sell and the offer to buy and provides a contract for sale and a contract for purchase to the at least one producer device and the at least one consumer device respectively.

In accordance with aspects of the present invention, the published price comprises current prices and future prices for the plurality of commodities. In accordance with aspects of the present invention, the at least one speculator device submits a prediction of a future price of the at least one commodity and submits an investment associated with the prediction. In accordance with aspects of the present invention, the intermediary market server aggregates all predictions received from all speculator devices, collects respective investments associated with the predictions, and holds the collected investments in escrow. In accordance with aspects of the present invention, the intermediary market server calculates a payment to each of speculators based on a percentage of an impact that the predication had on influencing the current price of the at least one commodity. In accordance with aspects of the present invention, the payment is a pari-mutuel payment based on commission to speculators paid from a total of investments paid by the speculators for the at least one commodity.

In accordance with aspects of the present invention, a cost of speculation is calculated by: V∫|log(P)−log(ΔP)|/R dt and a return on speculation is calculated by: V∫|log(PΩ)−log(ΔP)|dt=VD(PΩ, ΔP), where PΩ is a trading price, ΔP is a speculative price function, P(t) is a function of price over time, V(t) is an expected value to the market at any time and R(t) is a rate of return.

In accordance with an example embodiment of the present invention, a method for operating a commodity market through a coordinate discovery market is provided. The method includes publishing, by a marketplace device, current prices and future prices of commodities to producers, consumers, and speculators. The method also includes receiving, by the marketplace device, offers to sell a commodity at the current prices from the producers. The method further includes receiving, by the marketplace device, offers to buy the commodity at the current prices from the consumers. The method also includes matching, by the marketplace device, the offers to sell the commodity with the offers to buy the commodity. The method further includes providing, by the marketplace device, contracts for purchase to respective producers and consumers based on the matching. The method also includes receiving, by the marketplace device, confirmation of delivery of the commodity from the producers to the consumers. The method further includes releasing, by the marketplace device, escrowed funds of the consumers to the producers.

In accordance with aspects of the present invention, the method further includes receiving, by the marketplace device, predicted future prices of the commodities from the speculators. In accordance with aspects of the present invention, the method also includes receiving, by the marketplace device, investments associated with the predicted future prices from the speculators. In accordance with aspects of the present invention, the method further includes aggregating, by the marketplace device, the investments into a pool of investments. In accordance with aspects of the present invention, the method also includes calculating, by the marketplace device, a percentage of impact that the investments associated with predicted future prices had on determining actual future prices of the commodities. In accordance with aspects of the present invention, the method further includes augmenting, by the marketplace device, a commission share of trades produced by price information to the pool of investments. In accordance with aspects of the present invention, the method also includes releasing, by the marketplace device, pari-mutuel payments from the pool of investments to the “winning” speculators based on the calculated percentage of impact for the speculators.

In accordance with aspects of the present invention, an amount of the investments for a cost of speculation is calculated by: V∫log(P)−log(ΔP)|/R dt, where ΔP is a speculative price function, P(t) is a function of price over time, V(t) is an expected value to the market at any time, and R(t) is a rate of return. In accordance with aspects of the present invention, the pari-mutuel payments for a return on speculation is calculated by: V∫|log(PΩ)−log(ΔP) dt=VD(PΩ, ΔP), where: PΩ is a trading price, ΔP is a speculative price function, P(t) is a function of price over time, and V(t) is an expected value to the market at any time.

In accordance with an example embodiment of the present invention, a system for operating a commodity market through a coordinate discovery market is provided. The system includes a coordinated discovery market module configured to publish current prices and future prices of commodities to producers, consumers, and speculators. The system also includes a clearing house module configured to receive offers to sell a commodity at the current prices from the producers, receive offers to buy the commodity at the current prices from the consumers, and match the offers to sell the commodity with the offers to buy the commodity. The clearing house module is also configured to provide contracts for purchase to respective producers and consumers based on the matching, receive confirmation of delivery of the commodity from the producers to the consumers, and release escrowed funds of the consumers to the producers.

In accordance with aspects of the present invention, the coordinated discovery market module is further configured to receive predicted future prices of the commodities from the speculators. In accordance with aspects of the present invention, the clearing house module is further configured to receive investments associated with the predicted future prices from the speculators, aggregate the investments into a pool of investments, and calculate a percentage of impact that the investments associated with predicted future prices had on determining actual future prices of the commodities. The clearing house module is further configured to augment a commission share of trades produced by price information to the pool of investments and release pari-mutuel payments from the pool of investments to the winning speculators based on the calculated percentage of impact for the speculators.

In accordance with aspects of the present invention, an amount of the investments for a cost of speculation is calculated by: V∫|log(P)−log(ΔP)|/R dt, where: ΔP is a speculative price function, P(t) is a function of price over time, V(t) is an expected value to the market at any time, and R(t) is a rate of return. In accordance with aspects of the present invention, the pari-mutuel payments for a return on speculation is calculated by: V∫|log(PΩ)−log(ΔP)|dt=VD(PΩ, ΔP), where: PΩ is a trading price, ΔP is a speculative price function, P(t) is a function of price over time; and V(t) is an expected value to the market at any time.

### BRIEF DESCRIPTION OF THE FIGURES

These and other characteristics of the present invention will be more fully understood by reference to the following detailed description in conjunction with the attached drawings, in which:

FIG. 1 is an illustrative environment for implementing the steps in accordance with the aspects of the invention;

FIG. 2 is an illustrative system environment for implementing aspects of the invention;

FIG. 3 is an illustrative flowchart depicting operation of a traditional marketplace;

FIG. 4 is an illustrative flowchart depicting operation of the marketplace, in accordance with aspects of the invention; and

FIG. 5 is a diagrammatic illustration of a high level architecture for implementing processes in accordance with aspects of the invention.

### DETAILED DESCRIPTION

An illustrative embodiment of the present invention relates to a coordinated discovery market (CDM) which is configured to replace the traditional methodologies and logical constructs utilized within transactions on the conventional commodities marketplace. The CDM relies in part on game theory applied to the exchange markets and transactions performed in the commodities market. In particular, the CDM utilizes game theory to provide a coordination non-zero sum game in which all participants are rewarded for realizing mutual gains by making mutually consistent decisions. The CDM provides the incentives for making the mutually consistent decisions by establishing a metric space of potential Schelling points and providing a mechanism for market participants to perform transactions based on those Schelling points. The Schelling points allow the participants to evolve to a globally maximizing outcome by promoting equilibrium in the marketplace.

The Schelling points are implemented by the CDM such that they create a cost metric and a reward metric in the exchange marketplace in which participants can adjust the current Schelling point of the game by paying the cost metric and in return receiving a payment from the reward metric based on a quality level of the adjustment. As applied to the commodities market in accordance with the present invention, the Schelling points represent the price and a price sequence of a commodity and speculator participants can provide predictions of a future price of a particular commodity by providing an investment to move a price toward the prediction. The amount of the investment is determined according to the cost metric and speculators will be rewarded according to the reward metric and the accuracy of their prediction. In particular, the speculators will be rewarded for a level of influence provided to move a current price to an actual future price (e.g., the clearing price) of a commodity.

The coordination game marketplace provided by the CDM of the present invention includes three participant or player roles. The three player roles include the producers or makers, the consumers or users, and speculators. The producer roles are participants in the marketplace that make goods to be sold on the marketplace of the exchange market. The consumer roles are participants in the marketplace that are buyers of goods made available on the marketplace. Speculator roles are participants in the marketplace with the intent to profit from correctly projecting future price changes of goods exchanged on the marketplace. Additionally, the market or marketplace acts as an intermediary to facilitate transactions between each of the role players. The market is responsible for receiving and sharing price information, facilitating trades of goods between producers and consumers, and handling funds to be transferred between participants.

In the CDM, each of the three player roles shares a unique relationship with one another. The producer-consumer relationship is defined by the secure exchange of goods at ideal prices. The producer-speculator relationship is defined by the speculators attempting to project the price function that will fetch sufficient demand of consumers to meet the demand of suppliers (e.g., the clearing price). The producer-market relationship is defined by the desire of the producer to place goods up for sale on the market and the market informs the producer of distributions to consumers and provides funds in exchange for delivery of the goods. The consumer-speculator relationship is also defined by the speculators attempting to guess the price function that will fetch sufficient demand of consumers to meet the demand of suppliers. The consumer-market relationship is defined by the consumers agreeing to purchase a quantity of goods from producers and the market informing the consumer of the producer providing the goods and receiving the funds for payment of the goods upon delivery.

The market-speculator role is defined by the speculators providing predicted future price information to the market for publication to the producers and consumers. In CDM, the speculators pay an investment to the market based on the provided price information and an amount of distance the provided price will move from a current price. The market aggregates all speculated prices and associated investments from all participating speculators and pools the investments into a betting pool. Depending on an accuracy level of the provided prices, the market redistributes the investments in the betting pool in a pro rata basis of the amount of accurate price information contributed by each speculator. In particular, the market distributes funds to speculators based on a pari-mutuel system in which all spectator investments are placed together in a pool, commissions and fees are removed by the market, and payoff odds are calculated by sharing the pool among all speculator price predictions. The income for the speculators and market are both positively correlated with market volume, in particular, the market volume of trades between producers and consumers influenced by the prices provided by speculators.

The transactional process of the CDM starts with establishing a trading schedule which is then initiated by having speculator participants proposing a future trading price for a particular commodity (based on their own research, projections, and information), the market publishing those prices to all role players (speculators, producers, and consumers), and then at the future point in time, producers and consumers independently choosing a level of participation based on the proposed price. The market handles the transaction between the participating producers and consumers, providing delivery requirements, collecting funds and fees, and transfers funds accordingly. The speculators are rewarded by the market according to the level of participation the proposed price created in the producers and the consumers. For example, the speculators are rewarded for inspiring a greater volume of transactions between then producers and consumers inspired by the proposed price. Accordingly, the goal of the speculators is to provide a proposed price that closely predicts a clearing price for commodities, such that the lesser the amount that the price changes between iterations and the closer the sequence of participated price correspond to the clearing price function the higher the return and reward for speculators respectively. In an active commodity market there are multiple participants occupying each of the three roles for a given time period and it is possible and likely that producers and consumers will also participate as speculators.

The arrangement of the participants in the CDM and the transactions executed by the market within the CDM sets up a linked set of single price call auctions with a single market that carries no inventory (e.g., representative of a market maker with no inventory). This market collects a commission, from trades between producers and consumers, which may then be distributed back to the market operational expenses and a remainder to be distributed to the speculating participants, along with the speculator investments, based on the amount of quality information each speculator added to the marketplace. The speculators that provided the more accurate information will be provided a greater percentage of the overall pool than speculators that contributed less, if at all. Similarly, speculators that failed to contribute to projecting the clearing price will lose their investment and receive no cut of the overall pool.

By segregating competition, the CDM allows both competitive and cooperative incentives to operate, creating more opportunity for efficiencies in the exchange markets. Competition is confined within groups of participants such that speculators compete to provide better price forecasts, producers compete to produce more plentiful (and cheaper) goods, consumers compete to use more plentiful (and more expensive) goods. The market maintains its position through transparency and disinterest and maintaining trustworthiness by having the computers implement the algorithms. The CDM creates a global alignment of interests, so all participants gain or lose together, eliminating several categories of price manipulation found in traditional exchange markets. The information measurement of the price function provided by the CDM allows a restriction of the influence of speculators on the exchange markets while enhancing the value of the market for informed speculators and providing a means to directly state a degree of influence (positive or negative) of each participant in the market. Additionally, the CDM provides fair trade clearing without price or temporal priority given to traders on the exchange market, enabling price stasis across time windows long enough for human decisions to rule the market. By removing price and temporal priority, the CDM removes the speed advantage created by advances in communication or computation technologies. Lastly, the CDM provides a volume seeking price discovery in the exchange markets which allows for trusted fourth parties (e.g., producers, consumers, speculators, and the market itself) to referee the exchange market. The combination of a sequence of fixed price call auctions with a positive sum pari-mutuel information gathering provided by the CDM, facilitates the exchange of goods and services when the producers and consumers are complementary hedgers.

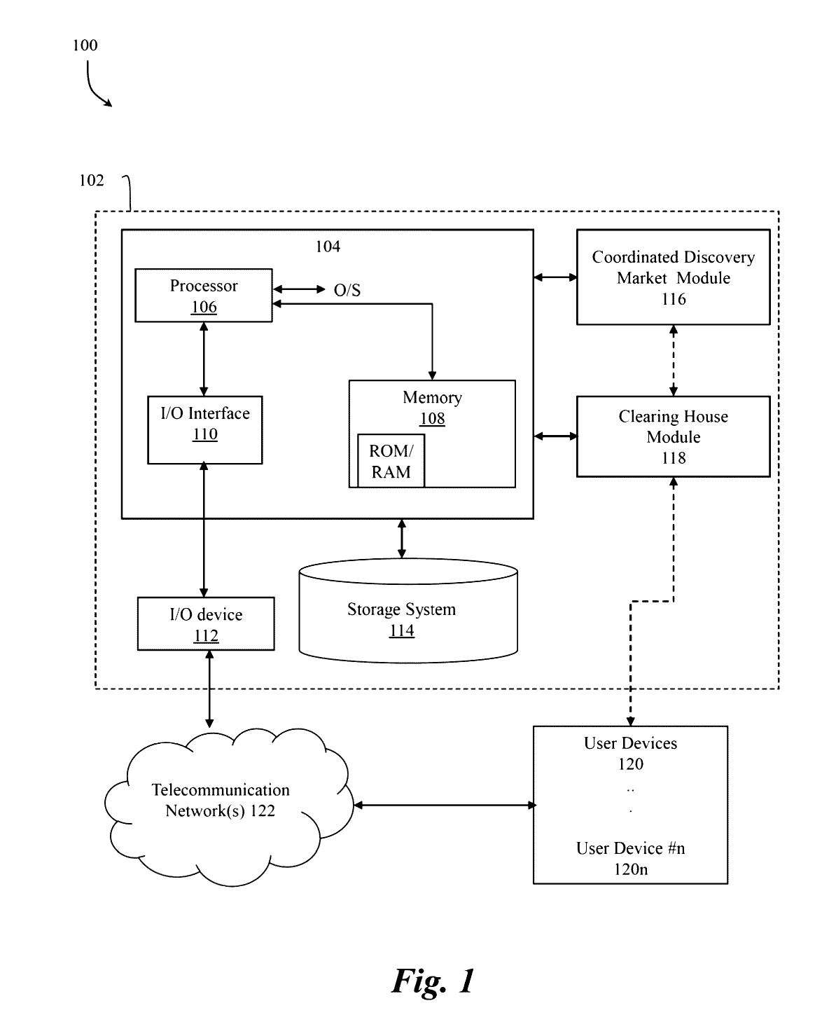

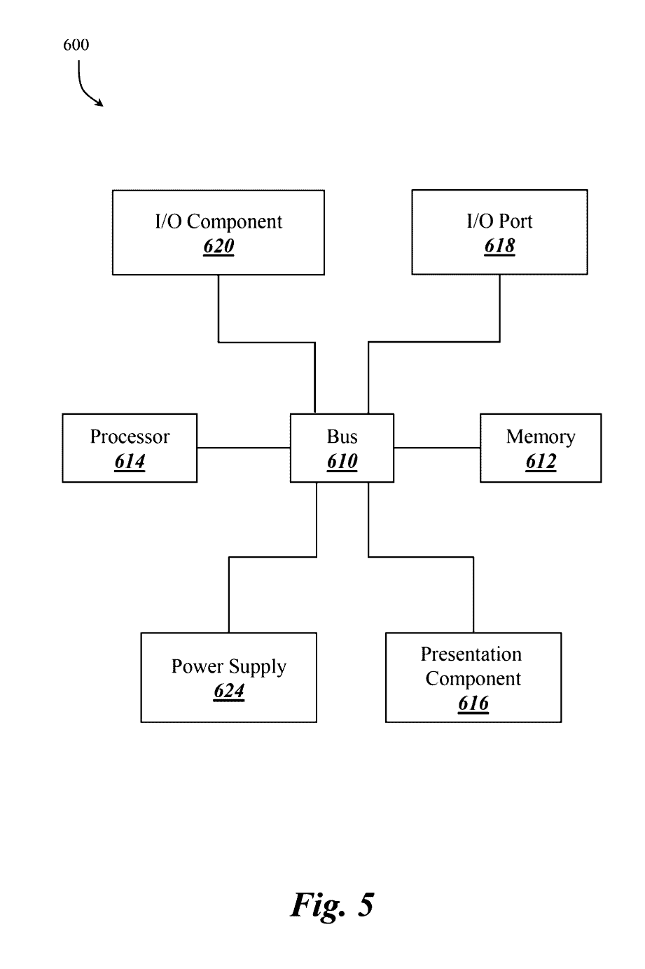

FIGS. 1 through 5, wherein like parts are designated by like reference numerals throughout, illustrate an example embodiment or embodiments of implementing the coordinated discovery market, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts an illustrative system 100 for implementing the steps in accordance with the aspects of the invention. In particular, FIG. 1 depicts a system 100 proving the CDM, including a marketplace computing system 102. In accordance with an example embodiment, the marketplace computing system 102 is a combination of hardware and software configured to carry out aspects of the present invention. In particular, the marketplace computing system 102 can be any combination of computing systems with specialized software and databases designed for publishing current and future prices of commodities received from speculators and facilitating transactions related to trading commodities between producers and consumers. For example, the marketplace computing system 102 can be software installed on a computing device, a web based application accessible by computing devices (e.g., the computing device 104), a cloud based application accessible by computing devices, etc. The combination of hardware and software that make up the marketplace computing system 102 are specifically designed to provide a technical solution to a particular problem utilizing an unconventional combination of steps/operations to carry out aspects of the present invention. In particular, the marketplace computing system 102 is designed to execute a unique combination of steps to provide a novel approach to handling pricing information and transactions in a commodity market. The resulting system provides a new logical construct and process for an exchange market.

In accordance with an example embodiment of the present invention, the marketplace computing system 102 can include a computing device 104 having a processor 106, a memory 108, an input output interface 110, input and output devices 112 and a storage system 114. The computing device 104 can include an operating system configured to carry out operations for the applications installed thereon. As would be appreciated by one skilled in the art, the computing device 104 can include a single computing device, a collection of computing devices in a network computing system, a cloud computing infrastructure, or a combination thereof, as would be appreciated by those of skill in the art. Similarly, as would be appreciated by one of skill in the art, the storage system 114 can include any combination of computing devices configured to store and organize a collection of data. For example, storage system 114 can be a local storage device on the computing device 104, a remote database facility, or a cloud computing storage environment. The storage system 114 can also include a database management system utilizing a given database model configured to interact with a user for analyzing the database data.

Continuing with FIG. 1, the marketplace computing system 102 can include a combination of core modules to carry out the various functions of the present invention. In accordance with an example embodiment of the present invention, the marketplace computing system 102 can include a coordinated discovery market module 116 and a clearing house module 118. As would be appreciated by one skilled in the art, the coordinated discovery market module 116 and the clearing house module 118 can include any combination or hardware and software configured to carry out the various aspects and) computations of the present invention. In particular, the coordinated discovery market module 116 and the clearing house module 118 are configured to provide users with a mechanism to exchange pricing information of commodities, facilitate transactions related to those commodities, and handle monetary payments related to those transactions. The coordinated discovery market module 116 is configured to receive, aggregate, and publish pricing information to and from the participants within the system 100. The clearing house module 118 is configured to receive offers of sale, offers to buy, produce contracts for the received offers, and receive and distribute funds for the contracted transactions.

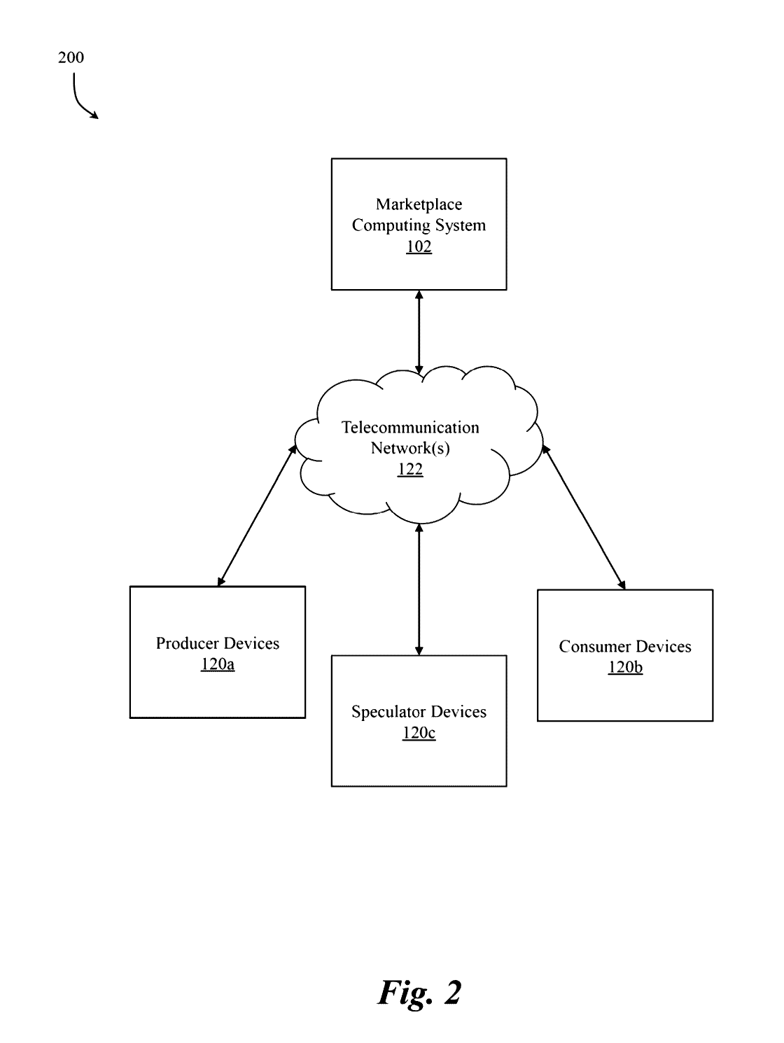

FIG. 2 depicts an illustrative CDM environment 200 for an implementation of the system 100 in accordance with aspects of the present invention. The system 100 includes but is not limited to the marketplace computing system 102 and a plurality of user devices 120a, 120b, 120c. The plurality of consumer devices can include producer devices 120a, consumer devices 120b, and speculator devices 120c. Each of the devices 120a, 120, 120c throughout the CDM environment 200 are configured to communicate over various telecommunication network(s) 122 to carry out aspects of the present invention. As would be appreciated by one of skill in the art, the telecommunication network(s) 122 can include any combination of known networks. For example, the telecommunication network(s) 122 may be combination of a mobile network, WAN, LAN, or other type of network. The telecommunication network(s) 122 may be used to exchange data between the marketplace computing system 102, the plurality of user devices 120a, 120b, 120c, and/or to exchange data with additional sources and devices.

Additionally, the marketplace computing system 102 and each of the user devices 120a, 120b, 120c can each include a computing device 104 as discussed with respect to FIG. 1. In particular, the plurality of user devices 120a, 120b, 120c can include any combination of computing devices 104 capable of operating software and communicating over the Internet. For example, the computing devices 104 can include a “workstation,” a “server,” a “laptop,” a “desktop,” a “hand-held device,” a “mobile device,” a “tablet computer,” a “smartphone”, or other computing devices, as would be understood by those of skill in the art. As would be appreciated by one skilled in the art, the computing devices 104 can be general purpose computers, specialized computing devices, or a combination thereof.

In operation, the marketplace computing system 102 acts as an intermediary device for managing the aggregation of current and future price information, the publication of pricing information, and the processing of transactions related to both trading commodities and speculating on the current and future prices of those commodities. The operation of the CDM, as it relates to facilitating exchanges of commodities, begins with the marketplace computing system 102 simultaneously publishing commodity current and predicted future price information to all user devices 120a, 120b, 120c within the CDM environment 200. Specifically, the marketplace computing system 102 shares the pricing information with producers, consumers, and speculators included within the CDM environment 200. The price information includes current prices and future (speculated) prices for commodities available for trading on the marketplace and the publishing is provided openly such that all pricing information is publicly available to all potential participants. For example, the marketplace computing system 102 can transmit the price information over a combination of computing devices (120a, 120b, 120c), webpages, etc. running software configured to receive and/or view price information provided by the marketplace computing system 102.

In accordance with an example embodiment of the present invention, the producers, consumers, and speculators receive price information updates from the marketplace computing system 102 for display within graphical user interfaces for CDM software installed on the producer devices 120a, consumer devices 120b, and speculator devices 120c. As would be appreciated by one skilled in the art, the price information can be transmitted from the marketplace computing system 102 to the each of the devices 120a, 120b, 120c and displayed utilizing any combination of methods known in the art. For example, the devices 120a, 120b, 120c can receive the price information over the telecommunication network(s) 122 as a live update on their market software (e.g., via the coordinated discovery market module 116), through an email message, a short message system (SMS), on displayed on a webpage in a presented in a web browser, etc.

In accordance with an example embodiment of the present invention, the price information published by the marketplace computing system 102 is based on price information received from informed speculators (e.g., via speculator devices 120c). The price information can be provided to the marketplace computing system 102 from a plurality of speculator devices 120c and the price information is updated, as scheduled by the market, based on the received information. As would be appreciated by one skilled in the art, the current price and future prices provided by the marketplace computing system 102 can be derived from the plurality of prices received from the speculator device 120c utilizing any algorithmic processing known in the art.

Based on the information provided by the marketplace computing system 102 and based on personal information and research done on the market, producers, consumers, and speculators perform a series of transactions that are transmitted to the marketplace computing system 102 via their respective user devices 120a, 120b, 120c. In accordance with an example embodiment of the present invention, each of the transactions is provided to the marketplace computing system 102 at the close of the trading window for the commodity market.

The producers and consumers will consider the received pricing information and their own market information/observations and make determinations whether to sell or buy inventory of commodities and at what quantities. In particular, the producers will transmit an offer to sell an amount between none and all, inclusive, of their produced commodity inventory at the published current price to the marketplace computing system 102 via their respective producer devices 120a. Similarly, the consumers will offer to buy any quantity that is desirable and affordable (including electing not to place an offer to buy any quantity) of the available commodity inventory at the published current price and submit the offer via their respective consumer devices 120b.

Each of the producers and consumers will independently provide their offers to the marketplace computing device 102, in particular, to the clearing house module 118 of the marketplace computing device 102. The clearing house module 118 is configured to fairly resolve consumer demand and producer supply by providing contracts of sale and purchase to the appropriate parties. In accordance with an example embodiment of the present invention, clearing house module 118 resolves transactions utilizing a system in which no priority is offered for a time that each transaction is placed. All transactions within a single trading window are treated equally. In particular, the CDM provided by the present invention will enable transactions between producers and consumers at a same single price per temporal window (e.g., per day). Additionally, the clearing house module 118 can collect the funds from the contracting consumers that are required to carry out the contracted transaction. As would be appreciated by one skilled in the art, the clearing house module 118 can provide the contracts and collect the funds utilizing any combination of methodologies known in the art.

The marketplace computing device 102 can match up participating producers and consumers based on the offers of sale and offers to buy received from the producer and consumer devices 120a, 120b and provide the corresponding contracts of sale. In accordance with an example embodiment of the present invention, the matching can be performed utilizing a bottom up approach performed by the clearing house module 118. In particular, the bottom up approach is initiated by aggregating all of the participating producer and consumer offers including the quantity of goods agreed to exchange in those offers. As would be appreciated by one skilled in the art, the producers and consumers and associated quantities can be resolved by aggregating data from the received offers to sell and purchase utilizing any methodologies and systems known in the art. The bottom up approach will trade one unit of goods between two entities and cycle through the entities one at a time while exchanging one unit of goods at a time until the quantity of goods is exhausted on either the producer and/consumer side of the transaction.

Continuing the example embodiment of the present invention, the bottom up process starts by assigning each identified producer and consumer a unique identifier and associating an initial quantity of commodities to be sold or purchased (from their respective offers) with the identified producer and consumer. The identifiers associated with the producers are grouped together in a list in random order and the identifiers associated with consumers are grouped together in a separate list in randomized order. Starting with the first producer and the first consumer in each list, the clearing house module 118 determines if the two entities have a remaining quantity of goods to trade. If each of the entities has a quantity remaining to provide, the clearing house module 118 increments the trade of one unit of goods between the entities and shifts each entity to the bottom of their respective lists. Otherwise, if an entity has exhausted the total quantity of goods, then the exhausted entity is removed from the list and the next entity will be shifted up and used in the transaction. This process repeats until only one or more entities exist in a single list or no entities in either list. When entities only remain in one list, then the remaining entities will have no trading partner and will be notified that the remaining quantities of their trading desires will remain unfulfilled. The incremented transactions between each pair of entities is tallied and a total amount of units to be transacted between entities will be provided in the contracts.

In an illustrative example of the bottom up processing, the marketplace computing device 102 receives offers of sale from Adam, Bob, and Carl. The offers to sell indicate that Adam is offering to sell 10 units, Bob is offering to sell 20 units, and Carl is offering to sell 30 units. Similarly, the marketplace computing device 102 receives offers to buy from Amy, Betsy, and Cathy. The offers to buy indicate that Amy is offering to buy 8 units, Betsy is offering to buy 16 units, and Cathy is offering to buy 24 units. The clearing house module 118 aggregates all of the offers and associates identifiers with each party, for purposes of this example the identifiers will be the names of the entities. The clearing house module 118 groups the producers (e.g., Adam, Bob, Carl) into a list and groups the consumers (e.g., Amy, Betsy, Cathy) a separate list. Each of the producers and consumers are associated with the quantity specified in their offer and the clearing house module 118 randomizes the order of the entities in their respective lists. In this example the resulting lists are Producers: Adam (10), Bob (20), Carl (30) and Consumers: Betsy (16), Amy (8), Cathy (24). The clearing house module 118 runs the bottom up process of single unit exchanges per party per cycle and cycles through the list until one of the lists is exhausted.

In this example the list of Betsy, Amy, and Cathy will exhaust first because there are less quantities in the offers to buy than there are offers to sell. The distribution resulting from the bottom up approach results in a fair distribution of Adam providing 10 units to Betsy, Bob providing 8 units to Amy, Bob providing 11 units to Cathy, Carl providing 6 units to Betsy, and Carl providing 13 units to Cathy. Bob is left with 1 unit unsold and Carl is left with 11 units unsold and they are each are notified accordingly. As would be appreciated by one skilled in the art, upon completion of the bottom up process the clearing house module 118 can provide each entity with contract information indicating the quantity, funding required, and transacting parties. For example, Adam will receive a contract to sell 10 units to Betsy at the clearing price per 10 units.

As would be appreciated by one skilled in the art, other resolution methodologies of trades between producers and consumers could be utilized. For example, the system 100 can utilize a preferred agent model for resolving trades. The resolution strategy for use with the present invention requires reward/punishment feedback to discipline forecasters such that it does not incentivize bad making offers. For example, proportional resolution type models would not work with the present invention because proportional resolution models create an incentive to deceive the market and reduce the quality of the information on the market.

In accordance with an example embodiment of the present invention, the contracts transmitted by the marketplace computing device 102 (via the clearing house module 118) will indicate the selling party, the buying party, the quantity of commodity in the transaction, and how the commodities should be delivered. As would be appreciated by one skilled in the art, the provided contracts can include all the additional information typically used in contracts, as known in the art. At a later point in time, the marketplace computing device 102 can receive delivery information from the producer, indicating that a contracted quantity of commodities has been delivered or is in transit to the appropriate consumer. During the same period of time, the consumers can provide the funds for the contracted quantity of goods to the clearing house module 118, which will be held in escrow. Additionally, the consumers can transmit an indication that the ordered quantity of commodities has been received to the market place computing device 102. Once the marketplace computing device 102 confirms delivery of the commodities, the funds from the consumer can be released from escrow to the delivering producer. Additionally, the marketplace computing device 102 can simultaneously transmit payments to the spectators based on their provided price information, as discussed in greater detail herein. In accordance with an example embodiment of the present invention, imposes a fixed transaction fee, which is less than the current total cost of a market it wishes to compete against, in order to fund the speculation and operation of the marketplace itself. The fixed commission on transactions are paid by the producers and consumers to market and divided between market operation and the pool paid to the speculators.

In contrast to the transactions performed in relation to the producer and consumer devices 120a, 120b, the speculator devices 120c have a distinct series of transactions with the marketplace computing device 102. The transactions performed by the speculator devices 120c have influence on and are affected by the transactions performed by the producer and consumer devices 120a, 120b. The spectators, however, do not directly perform any transactions with either the producers or consumers. Instead, the speculators provide predictions on future prices or clearing prices of commodities which are backed by a financial investment placed with the market (e.g., the marketplace computing device 102) by the speculator. In response to transactions being processed by the marketplace computing device 102 between producers and consumers at a given price, the speculators can be rewarded from the investment pool based on a level of accuracy in predicting the clearing price (e.g., predicted future price) of the commodities exchanged between producers and consumers (e.g., via a pari-mutuel schema). The speculation and reward scheme provided by the present invention is a direct contrast to traditional speculation market systems and methodologies. In particular, traditional systems and methods reward or punish speculators based on a difference in the spread between their predicted prices and the actual prices. In particular, in conventional schemas, speculators are rewarded for buying low and selling high. In contrast, speculators in CDM of the present invention are rewarded when the provided predicted prices accurately match the actual future prices or clearing prices of commodities. Accordingly, in the present invention, the less the speculation moved the market toward and the actual future price, the less the reward, if any.

In operation, the speculators provide input on future prices of commodities based on their personal interpretation and research related to the marketplace including but not limited to environmental conditions, anticipated shortages or overages of production, etc. Additionally, speculators can review current prices and future prices published by the marketplace computing device 102 (e.g., via the coordinated discovery market module 116) and determine whether the future prices are currently on point with their expectations. For example, each of these predictions and agreements can be transmitted to the coordinated discovery market module 116 of the marketplace computing system 102 via the speculator devices 120c associated with the speculators. The role of speculators in the present invention is dictated by a betting pools schema in which the speculators pay an investment or wager to the marketplace based on their predicted future prices of commodities. The amount of the investment provided by the speculators can be correlated to a confidence level and/or level of risk that the speculator perceives in the price prediction. In exchange, based on the prediction and the value of the investment, the marketplace commits to pay the at least a portion of the speculators a reward based on the actual future prices of the commodities so long as any part of their speculation turns out to be correct (e.g., contributed to the actual future prices).

The coordinated discovery market module 116 receives and aggregates all of the price predictions provided by the speculator devices 120c and the clearing house module receives the investments associated with those predictions to be published and utilized in the reward calculations. As would be appreciated by one skilled in the art, the investments can be provided by the speculators using any method known in the art and stored in the investment pool (e.g., escrow) until payment is required. For example, the clearing house module 118 of the marketplace computing device 102 can receive electronic funds, wire transfers, credit payments, confirm the funds, and place the appropriate funds in escrow. In accordance with an example embodiment of the present invention, the betting pool schema is a pari-mutuel betting schema and the rewards are determined based on a calculation of a percentage of change that each speculator prediction and investment influenced an actual future price of a commodity, as discussed in greater detail herein. Accordingly, each contributing speculator will be paid the fraction of impact that their investment had on moving the current market price toward the actual future market price, if any.

As would be appreciated by one skilled in the art, the producer, consumer, and speculator devices 120a, 120b, 120c can each generate a graphical user interface to provide users with a means to view, enter, and transmit their respective information with the marketplace computing system 102. Additionally, the information transmitted between devices 120a, 120b, 120c, and 102 can be transmitted utilizing any transmission methodologies known in the art.

In accordance with an example embodiment of the present invention, the coordinated discovery market module 116 calculates both an amount of an investment that is required to submit a given price speculation and an amount of a return, if any, to be paid to each participating speculator. The cost of speculation equation and the return on speculation equation compare and price the difference between various points in time (P(t)) such that the general features of these equations is that large or quick or high-volume market price changes are more expensive and small or slow or low-volume market changes are less expensive. The process arrangement of the present invention and the equations that support them allows the separation of speculation from trading so that speculator incentives can be inverted to align with producers and consumers, thereby aligning the fiscal interests of all end users with the speculators. Additionally, the accuracy of the prices increases the volume of trade which increases the reward to the speculators pari-mutuel schema, which is divided up on the basis of the contributing fraction of the individual speculators settlement which in turn increases the accuracy of the prices.

In accordance with an example embodiment of the present invention, the amount of an investment required from a speculator is calculated by executing the following cost of speculation equation: V∫|log(P)−log(ΔP)|/R dt. The variables for the cost of speculation equation are as follows: P represents a variable of price, P(t) is a variable function of price over time in a given market, ΔP represent a speculative price function. P(t) can mathematically represent the future prices as functions of price over time. The function value of R(t) is a predetermined value for the rate of return. For example, for R(t), the value can be 100% annualized so for a t in years R(1)=2, R(2)=4 and R(0.5)=1.414, but as would be appreciated by one skilled in the art, any function is possible. The value for V(t) at any given time is the expected value to the market (e.g., volume of goods to trade multiplied by the market commission) The value for V(t) can be updated empirically as the commodities market functions by calculation as a moving average of volume times the markets total transactional overhead charge.

Accordingly, the cost of speculation equation fulfills all of the desirable properties: V will vary with market size making high-volume markets more expensive to speculate in than low-volume markets, |log(P)−log(ΔP)| increases the greater the change in proposed prices, and R provides a temporal scaling factor making the distant future cheaper than the near future. Utilizing the cost of speculation equation, the market can publish a schedule of future prices which can be changed to some other future prices by paying an appropriate amount to the exchange based on the distance of the proposed change from a current price. Additionally, by weighting the speculation price by the volume transacted through the market, market deranging changes become cheap to correct once buyers and sellers fall out of balance. Because speculators can only increase their collective income by increasing trade volume and because the pace of operation is at human rather than computer speeds the operational costs of markets using this design is considerably lower than existing systems. As would be appreciated by one skilled in the art, any combination of different equations and variables can be utilized to carry out the cost of speculation aspect of the present invention without departing from the overall operation of the present invention.)

The following is an exemplary implementation of the cost of speculation equation in practice in accordance with the present invention. As would be appreciated by one skilled in the art, the following example is for explanation purposes only and not intended to limit the use of the cost of speculation equation to this implementation. Sam the speculator believes that on a certain day in the future a price for a commodity that is currently published at $5 should be priced at $10 (e.g., future price). Sam the speculator provides the predicted price to the market (e.g., the marketplace computing device 102) and provides an investment to back up the prediction (e.g., transfers funds into an escrow account via the clearing house module 118). The marketplace computing device 102 utilizes the cost of speculation equation to determine if Sam the speculator has provided a sufficient investment to support a change in price. In particular, the cost of speculation equation calculates how much money it takes, given a current state of the market, to move the price.

If the marketplace computing device 102 determines that the investment provided by Sam the speculator is sufficient based on the calculation provided by the cost of speculation equation, then the marketplace computing device 102 updates the current projection for the future price. Thereafter, the marketplace computing device 102 stores a record of the projected price movement to be utilized later for calculating the pari-mutuel rewards, if any. Otherwise, if the marketplace computing device 102 determines that the investment provided by Sam was not sufficient to fully move the current price (e.g., $5) to his predicted price ($10), then the marketplace computing device 102 computes the maximum distance towards $10 it can move the price and then does so. As would be appreciated by one skilled in the art, the marketplace can calculate the maximum distance utilizing the cost of speculation equation and performing a binary search for the highest value ΔP that can be afforded by the investment commitment is done. Alternatively an invertible metric could be selected allowing a direct calculation of the maximum distance. Additionally, if the investment provided by Sam the speculator is insufficient to move the price (e.g., the price had already been moved to $10 before Sam came up in the resolution phase or Sam didn't put up enough to move the price a single penny), then the clearing house module 118 releases Sam the speculator's investment from escrow back to him unspent.

In accordance with an example embodiment of the present invention, the return on speculation equation is V∫|log(PΩ)−log(ΔP)|dt=VD(PΩ, ΔP). The marketplace computing device 102 utilizes the same collection of variables from the cost of speculation equation, and some additional variable(s) to calculate a return on speculation or rewards equation. The additional variable for PΩ in the return on speculation equation is the function of actual current market trading prices. The distance between the current price and the predicted price can be solved with the function: D(P, ΔP)=∫|log(P)−log(ΔP)|dt. The result of the return on speculation equation is an index which is summed with all indices from all speculators, the result of dividing the individual contribution by the group is the fractional value that the speculator will be paid out of the pari-mutuel investment pool. The return on speculation equation offers maximum returns for investments and price predictions (e.g., as provide in the cost of speculation equation) that actually change the price on the marketplace correctly, and a zero return for not changing the market price or changing the market price incorrectly. As would be appreciated by one skilled in the art, a different equation and variables can be utilized to carry out the return on speculation or reward aspect of the present invention without departing from the overall operation of the present invention.

In accordance with an example embodiment of the present invention, the rewards for speculators are calculated and pari-mutuel payments are made to the appropriate speculators based on the commission(s) calculated from the return on speculation equation. The return on speculation equation for speculators in the present invention provides a unique mechanism for speculators to purchase a speculation on a future price and profit from transactions executed between producers and consumers at an actual future price influenced by that speculation. This is in contrast to traditional commodity market exchanges in which the speculators are active participants agreeing to purchase an amount of commodities and agreeing to sell those commodities at a future date at a future price (although the speculators may never possess or intend to possess the actual goods).

In particular, the return on the speculation equation is applied to each good speculation that is the portion of a speculation which with the benefit of hindsight can be seen to have been correct, in turn to generate an index. The indices resulting from processing the return on section equation are the proportional payouts from the augmented pari-mutuel pool. In other words, the return is a fractional payout of the pari-mutuel payments for speculation augmented by the portion of (V) designated for rewarding informed speculation. The fraction is based on the proportional information provided as measured using Shannon information. For example, the fractional payout equals an absolute log of speculation towards price settlement (use if-else to truncate counter-productive price movement) divided by the sum of all contributors to final settlement. This is made straightforward because the metric space corresponds to Shannon information measures. Once a price becomes current the history of speculations is evaluated. Each speculation is divided into helpful and unhelpful, for example if Sam the speculator succeeded in moving the price from $5 to $10 and the price ultimately settled at $8 then the move from $5 to $8 would be helpful and the remainder discarded. Each helpful move is measured and the measurement is added to the speculator's index and a running total. The system then divides each speculator's index of helpfulness by the total of all helpfulness and is rewarded by the contributing fraction of the augmented pari-mutuel investment pool.

The following is an exemplary implementation of the return on the speculation equation in practice. As would be appreciated by one skilled in the art, the following example is for explanation purposes only and not intended to limit the use of the return on the speculation equation to this implementation. In particular, the following example provides an implementation as to how a speculator is rewarded according to the return on speculation equation. If the marketplace computing device 102 determines that an investment provide by Sam the speculator changed the current price in marketplace from $5 to $6, utilizing the return on speculation equation, and all other speculators agreed with the change provided by Sam the speculator, then Sam the speculator would get 100% of the investment pool and all the other speculators would not make any investments. As would be appreciated by one skilled in the art, agreement is when no dissenting speculations are entered into the system, it covers the event that global consensus about price evolution of a given trading period has been achieved

If however, several speculators contributed to change the current price from $5 to an actual future price of $6 and all other speculators agreed, then the marketplace computing device 102 would calculate a breakdown between the several speculators based upon how much each investment by each respective speculate changed the price. For example if the first speculator invested enough to entirely change the market price, then the first speculator would get 100% of the investment pool. However if two speculators contributed investments that changed the price by 20% and two other speculators contributed investments that changed the price by 30% then the reward from the investment pool would breakdown accordingly (e.g., two would get 20% and two would get 30% of the pool).

In an additional example, the rewards can be impacted by speculators with disagreeing price changes. For example, there are speculators Alex, Bob, and Carl. Alex provides an investment that changes the current price from $5 to $6, then Bob provides an investment that changes the current price from $6 to $5, and then Carl provides an investment that changes the current price back from $5 to $6 and then everybody agrees, including Alex, Bob, and Carl. In this example, Alex and Carl are equal partners at 50% each and the investment contributed by Bob will be divided between them (along with each of their initial investments) for his 0% performance.

In the present invention, speculators do not purchase or handle any commodities, instead the speculators are merely speculating on future prices of the commodities and trying to influence those future prices based on their investment. Accordingly, the goal of the speculators in the present invention is to try and move the future price of a commodity to an amount matching their predicted future price for that commodity. Thus the largest gains for speculators in the CDM is available from the biggest correct moves to the actual future prices. Traditional speculators would find such a situation undesirable because they prefer that the market does not move so that they can capitalize on the difference in price (e.g., buy low and sell high). The CDM model implemented by the marketplace computing system 102 will reward the appropriate speculators out of the investment pool of funds populated by investments from the speculators. In particular, the speculators who contribute to changing the price of a commodity are rewarded according to the pari-mutuel betting schema, as discussed herein. As would be appreciated by one skilled in the art, the use of speculator investments to provide part of eventual investor payout creates a non-negative sum game. In contrast, traditional commodity exchanges provide methods in which investor funds are committed to contract commitments (e.g., contracts to buy and sell commodities between producers and consumer) the fate of which determines the loss/return of the investment of the speculators. As a result of speculators being paid out of the pool of investments, in the present invention, the speculators cannot lose more money than was initially invested. This is also in contrast to traditional commodity markets in which a negative price fluctuation in a commodity can result in the speculator owing more than was initially invested.

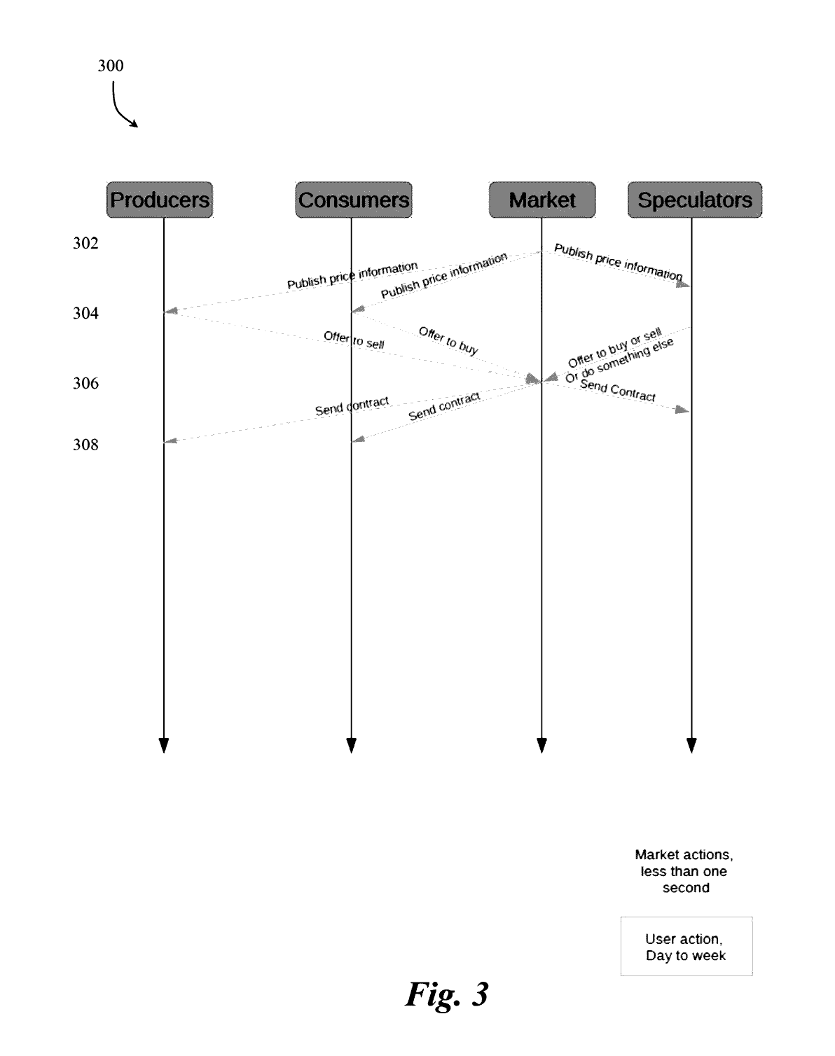

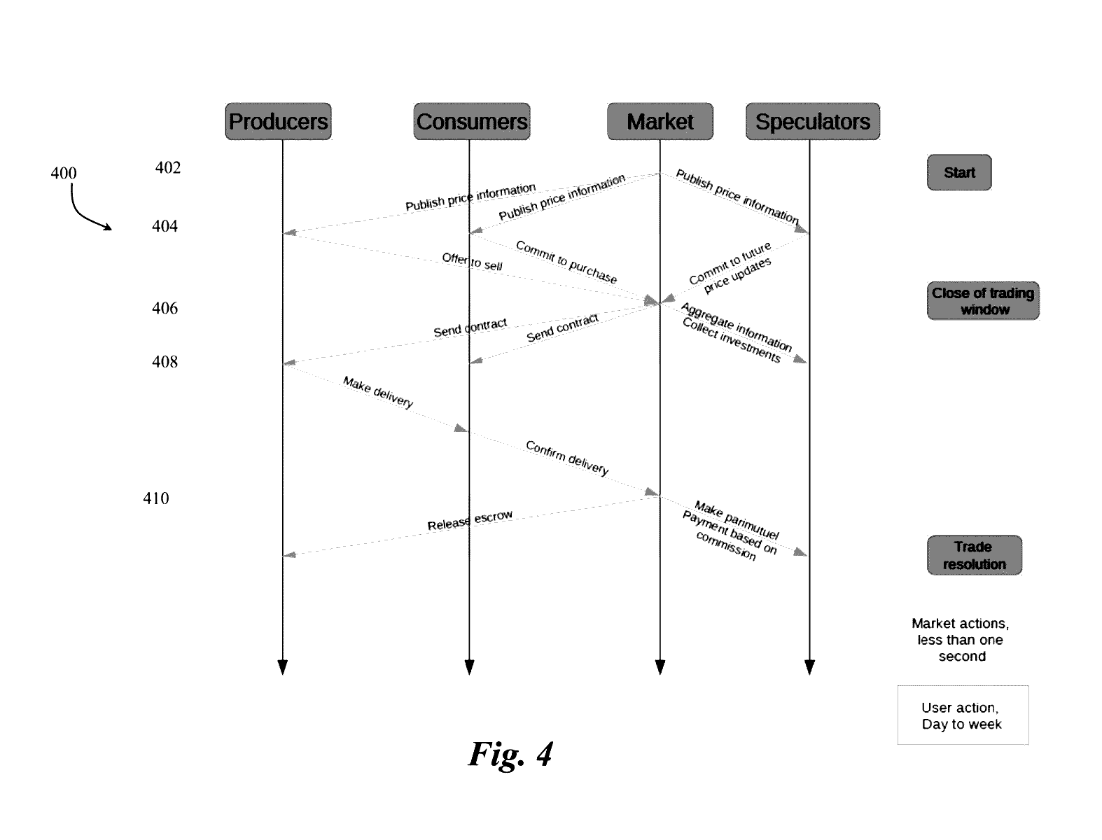

FIGS. 3 and 4 show exemplary flow charts depicting methodologies for processing transactions between participants within exchange markets. Specifically, FIG. 3 depicts an exemplary process 300 of a traditional exchange market. At step 302, the process 300 initiates by the market publishing price information to the participants within the system and advances to step 304. The participants in system include producers, consumers, and speculators. As depicted in FIG. 3, the publication of price information takes less than one second due to the advancement in communication and computing technologies. At step 304, each of the participants can perform some action based on the published price information. The producers can elect to offer to sell none, some, or all of their available produced goods. Similarly, the consumers can elect to offer to buy none, some, or all of the available produced goods. As depicted in FIG. 3, the producer and consumer transactions are user actions that can take a period of time ranging from a day to multiple days.

The speculators can make an offer to buy or sell an interest in the goods or do something else (e.g., nothing, cancel orders before they fill, add additional orders, etc.). Unlike the producer and consumer process at step 304, the speculator actions are market actions that take less than one second to complete. At step 306, the market provides contracts to the participating producers, consumers, and speculators, based on the received offers to buy and offers to sell. As would be appreciated by one skilled in the art, these contracts are produced utilizing any methodologies currently known in the art. As depicted in FIG. 3, the contracts are provided in less than one second due to the advancement in communication and computing technologies. At step 308, the terms of the contracts are fulfilled by the contracting parties. For example, producers will ship the goods to the appropriate consumers and consumers will provide funds for the contracted goods to be paid to the producers (e.g., via escrow).

FIG. 4 depicts an exemplary process 400 of the logical model provided by the CDM. At step 402, the process 400 initiates by the market publishing price information to the participants within the system and advances to step 404. The participants in system include producers, consumers, and speculators. As discussed herein, the price information including the current prices for commodities and projected future prices of those commodities as provided by the speculators. Step 404 differs from the conventional step 304 of FIG. 3 because the market is publishing trading data (e.g., prices) for both the present and scheduled future times. As depicted in FIG. 4, the publication of price information takes less than one second due to the advancement in communication and computing technologies.

At step 404, each of the participants can perform some action based on the published price information. The producers can commit to sell none, some, or all of their available produced goods. Similarly, the consumers can commit to offer to buy none, some, or all of the available produced goods. As would be appreciated by one skilled in the art, the commitments are for delivery, while offers, made by speculators in traditional systems, are indistinguishably made by speculators whose profits are realized if and only if a spread appears for them to take advantage of, this is the root cause of the oppositional incentives of producers and consumers on one hand and speculators on the other in the traditional markets. The speculators commit to future price updates including providing predicted future price information to the market, as discussed herein. In particular, the speculators provide future price projections to the market along with an investment to support those projections. As depicted in FIG. 4, the producer, consumer, and the speculator transactions are user actions that can take a period of time ranging from a day to multiple days.

At step 406, the market provides contracts to the participating producers, consumers, and speculators, based on the received offers to buy and offers to sell. In accordance with an example embodiment of the present invention, the contracting parties and quantities of goods are determined utilizing a fair distribution algorithm (e.g., the bottom up algorithm), as discussed in greater detail herein. The utilization of the fair distribution algorithm differs from the conventional approach from FIG. 3 because it eliminates both temporal and price advantages. Once the contracting parties are determined, the market generates the contracts and transmits them to the corresponding parties. As would be appreciated by one skilled in the art, the contracts can be produced utilizing any methodologies currently known in the art.

Additionally, at step 406, the market aggregates future price predictions from the speculators and collects investments from the speculators to back the price predictions. As discussed in greater detail herein, the investments provided by the speculators are provided to an investment pool in which rewards are paid to one or more of the speculators at a later step (e.g., step 410). This differs from the conventional approach provided in FIG. 3 in which speculators commit themselves to future purchases and/or sales of goods from the producers and the prices of these agreements are published. Moreover, the process of collecting investments to be included as part of eventual investor payout providing investors a non-negative sum game is a further distinction because existing methods, such as depicted in FIG. 3, commit investor funds to contract commitments with producers. As depicted in FIG. 4, the contracts are provided in less than one second due to the advancement in communication and computing technologies.

At step 408, the terms of the contracts are fulfilled by the contracting parties (e.g., the producers and consumers). For example, producers will ship the goods to the appropriate consumers and consumers will confirm delivery. At this step, consumers can provide funds for satisfying the transaction to the market. As would be appreciated by one skilled in the art, the funds can be held in escrow by the market until confirmation of the reception of the goods is received from the consumer. Additionally, at step 408, the market can charge the producers and consumers a fee for facilitating the transaction. The fees can be used by the market to cover operating costs and to contribute to the investment pool for rewards paid to speculators.

At step 410, the market will release the funds from escrow to the producer. In particular, once confirmation of the delivery of the goods from step 408 is determined, then the market can release the funds from escrow to the producer, completing the transaction. Additionally, at step 410 the market will make the pari-mutuel fractional payment(s) to the appropriate speculators from the investment pool based on the return on investment calculation, as discussed herein. In particular, the market will calculate the fractional reward to be paid from the investment pool, if any, for each participating speculator utilizing the reward on speculation equation. Once the fractional rewards are calculated, the market will transmit the rewards to the appropriate speculator. As would be appreciated by one skilled in the art, the rewards can be transmitted to the speculators using any system and method known in the art (e.g., wire transfer, electronic check, etc.).

As a result of the process 400 in FIG. 4, all four participants want the same thing, for maximum trades at clearing prices to occur. By offering a pari-mutuel system with commissions the speculators enjoy a positive sum game rather than the negative sum game provided by the process 300 in FIG. 3 that confronts investors currently. Additionally, the risk is contained to whatever level of monetary commitment chosen at the time of speculating. The average return on the risk assumed by the speculator may be set to any level desired and so people capable of correcting the marketplace can enjoy average returns on investment which are higher than any historical example from existing markets. The producers and consumers enjoy a marketplace with lower total costs of transaction and an effective suspension of the need to hedge.

Any suitable computing device can be used to implement the computing devices 102, 104, 120a, 120b, 120c and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 6. The computing device 600 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for discovering and publishing clearing prices of commodities within exchange markets, the system comprising:
an intermediary market server which simultaneously publishes price for a plurality of commodities to at least one speculator device associated with a speculator, at least one producer device associated with a producer of at least one commodity, and at least one consumer device associated with a consumer of at least one commodity;
wherein the at least one speculator device exchanges data with the intermediary market server related to purchasing interests in at least one commodity of the plurality of commodities;
wherein the at least one producer device exchanges data with the intermediary market server related to selling the at least one commodity; and
wherein the at least one consumer device exchanges data with the intermediary market server related to buying the at least one commodity.

2. The system of claim 1, wherein the published price is received from one or more of the at least one speculator device.

3. The system of claim 1, wherein the at least one producer device is configured to submit an offer to sell a portion of the at least one commodity at the published price.

4. The system of claim 3, wherein the at least one consumer device submits an offer to buy the portion of the at least one commodity at the published price.

5. The system of claim 4, wherein the intermediary market server resolves the offer to sell and the offer to buy and provides a contract for sale and a contract for purchase to the at least one producer device and the at least one consumer device respectively.

6. The system of claim 1, wherein the published price comprises current prices and future prices for the plurality of commodities.

7. The system of claim 6, wherein the at least one speculator device submits a prediction of a future price of the at least one commodity and submits an investment associated with the prediction.

8. The system of claim 7, wherein the intermediary market server aggregates all predictions received from all speculator devices, collects respective investments associated with the predictions, and holds the collected investments in escrow.

9. The system of claim 8, wherein the intermediary market server calculates a payment to each of speculators based on a percentage of an impact that the predication had on influencing the current price of the at least one commodity.

10. The system of claim 9, wherein the payment is a pari-mutuel payment based on commission to speculators paid from a total of investments paid by the speculators for the at least one commodity.

11. The system of claim 1, wherein:
a cost of speculation is calculated by:
V∫|log(P)−log(ΔP)|/R dt; and
a return on speculation is calculated by:
V∫|log(PΩ)−log(ΔP)|dt=VD(PΩ, ΔP)
where:
PΩ is a trading price;
ΔP is a speculative price function;
P(t) is a function of price over time;
V(t) is an expected value to the market at any time; and
R(t) is a rate of return.

12. A method for operating a commodity market through a coordinate discovery market, the method comprising:
publishing, by a marketplace device, current prices and future prices of commodities to producers, consumers, and speculators;
receiving, by the marketplace device, offers to sell a commodity at the current prices from the producers;
receiving, by the marketplace device, offers to buy the commodity at the current prices from the consumers;
matching, by the marketplace device, the offers to sell the commodity with the offers to buy the commodity;
providing, by the marketplace device, contracts for purchase to respective producers and consumers based on the matching;
receiving, by the marketplace device, confirmation of delivery of the commodity from the producers to the consumers; and
releasing, by the marketplace device, escrowed funds of the consumers to the producers.

13. The method of claim 12, further comprising:
receiving, by the marketplace device, predicted future prices of the commodities from the speculators;
receiving, by the marketplace device, investments associated with the predicted future prices from the speculators;
aggregating, by the marketplace device, the investments into a pool of investments;
calculating, by the marketplace device, a percentage of impact that the investments associated with predicted future prices had on determining actual future prices of the commodities;
augmenting, by the marketplace device, a commission share of trades produced by price information to the pool of investments; and
releasing, by the marketplace device, pari-mutuel payments from the pool of investments to the “winning” speculators based on the calculated percentage of impact for the speculators.

14. The method of claim 13, wherein:
an amount of the investments for a cost of speculation is calculated by:
V∫|log(P)−log(ΔP)|/R dt
where:
ΔP is a speculative price function;
P(t) is a function of price over time;
V(t) is an expected value to the market at any time; and
R(t) is a rate of return.

15. The method of claim 13, wherein:
the pari-mutuel payments for a return on speculation is calculated by:
V∫|log(PΩ)−log(ΔP)|dt=VD(PΩ, ΔP)
where:
PΩ is a trading price;
ΔP is a speculative price function;
P(t) is a function of price over time; and
V(t) is an expected value to the market at any time.

16. A system for operating a commodity market through a coordinate discovery market, the system comprising:
a coordinated discovery market module configured to:
publish current prices and future prices of commodities to producers, consumers, and speculators;
a clearing house module configured to:
receive offers to sell a commodity at the current prices from the producers;
receive offers to buy the commodity at the current prices from the consumers;
match the offers to sell the commodity with the offers to buy the commodity;
provide contracts for purchase to respective producers and consumers based on the matching;
receive confirmation of delivery of the commodity from the producers to the consumers; and
release escrowed funds of the consumers to the producers.

17. The system of claim 16, wherein the coordinated discovery market module is further configured to receive predicted future prices of the commodities from the speculators.

18. The system of claim 16, wherein the clearing house module is further configured to:
receive investments associated with the predicted future prices from the speculators;
aggregate the investments into a pool of investments;
calculate a percentage of impact that the investments associated with predicted future prices had on determining actual future prices of the commodities;
augment a commission share of trades produced by price information to the pool of investments; and
release pari-mutuel payments from the pool of investments to the winning speculators based on the calculated percentage of impact for the speculators.

19. The system of claim 18, wherein:
an amount of the investments for a cost of speculation is calculated by:
V∫|log(P)−log(ΔP)|/R dt
where:
ΔP is a speculative price function;
P(t) is a function of price over time;
V(t) is an expected value to the market at any time; and
R(t) is a rate of return.

20. The system of claim 18, wherein:
the pari-mutuel payments for a return on speculation is calculated by:
V∫|log(PΩ)−log(ΔP)|dt=VD(PΩ, ΔP)
where:
PΩ is a trading price;
ΔP is a speculative price function;
P(t) is a function of price over time; and
V(t) is an expected value to the market at any time.
